(19) United States
(12) Patent Application Publication
(10) Pub. No.: US 2019/0292698 A1
(43) Pub. Date: Sep. 26, 2019

(54) UNITARY DOUBLE-KNIT FABRIC ADAPTED TO PROVIDE INTRINSIC CHAMBERS AND PASSAGEWAYS FOR HOLDING AND PASSING EXTRINSIC OBJECTS, AND A METHOD OF MAKING THE SAME

(71) Applicant: Abigail Leigh Kempson, Philadelphia, PA (US)

(72) Inventor: Abigail Leigh Kempson, Philadelphia, PA (US)

(21) Appl. No.: 16/362,014

(22) Filed: Mar. 22, 2019

Related U.S. Application Data
(60) Provisional application No. 62/646,747, filed on Mar. 22, 2018.

(51) Int. Cl. D04B 21/20; B32B 5/26; D04B 21/06

(52) U.S. Cl. CPC D04B 21/20; B32B 5/26; D10B 2403/0213; D10B 2501/061; D10B 2403/033; D04B 21/06

(57) ABSTRACT

A unitary double-knit fabric adapted to provide intrinsic chambers, pockets, and passageways for holding and passing extrinsic objects therein and therethrough, and a method of making the same.

### CROSS-REFERENCE TO RELATED APPLICATION

This application claims the benefit of priority of U.S. provisional application No. 62/646,747, filed Mar. 22, 2018, the contents of which are herein incorporated by reference.

### BACKGROUND OF THE INVENTION

The present invention relates to double knit fabrics and, more particularly, a unitary double-knit fabric adapted to provide intrinsic chambers, pockets and passageways for holding and passing extrinsic objects therein and therethrough, and a method of making the same.

Regular knit fabrics do not have the interior chamber created by double knitting. Double knitting as it is known today does not allow for foreign objects to be inserted into the fabric. As a result, extra fabric has to be sewn on, adding stitches to two separate pieces of fabric, to create pockets, passages, or chambers, which is time consuming and can create unsightly lumps and bumps, or loose ends. This can create a clunky or bumpy aesthetic, as well as unseemly ends to be woven in, which lowers the value to users and wearers of the fabrics.

As can be seen, there is a need for unitary double-knit fabric adapted to provide intrinsic chambers and passageways for holding and passing extrinsic objects therein and therethrough, and a method of making the same. The present invention embodies the process which solves the problem of how to make a two surfaced fabric with pockets or passages for foreign objects all in one go, without having to return to the fabric to sew on additional pieces or sew barriers between chambers.

The present invention enhances regular double knitting, thus allowing either intrinsic closed pockets/chambers containing an extrinsic object to be permanently installed, or enabling the creation of an intrinsic passageway that allows an extrinsic object to be passed back and forth inside the fabric. The result is an aesthetically smooth fabric that has no trailing ends or unseemly bumps, wherein the only lumps are by choice, created by the extrinsic object.

The present invention is different from regular knitting because regular knit fabrics do not have the interior chamber created by double knitting. The present invention differs from double knitting because it creates a process that allows for extrinsic objects to be introduced between the two halves of the fabric. It is better that sewing on a pocket, chamber, or passage, because it eliminates any unseemly bumps, lumps, or loose ends created by sewing. Instead, the process allows for intrinsic passages, pockets, and chambers to be created at the same time as the rest of the cloth, creating a seamless, elegant, unitary look for blankets, toys, scarves, hats, vests, sweaters, shirts, pants, skirts, dresses, robes, frocks and the like. The processes embodied in the present invention also enables the enmeshment of knitted fabric and object, including but not limited to the following: a fusion of toys and clothing, for example: a scarf that is also a maze, allowing you to push a marble from one end to the other; a fusion of clothing and tools, for example: a scarf that has coins, ball bearings, or other small, heavy objects knit into the ends that can then double as a self-defense weapon, much like a bola; a fusion of blankets and tools, for example: a blanket that has a space to slip a hot water bottle or heater of some sort; and the like, for example the creation of protective wear, such as a double-knit KevlarTM vest with chambers that can hold additional protective materials.

### SUMMARY OF THE INVENTION

In one aspect of the present invention, a knitting method for knitting a seamless fabric having an intrinsic pocket includes a first knit filament; a second knit filament; the first knit filament and the second knit filament are integrally knitted through a plurality of rows so as to be connected seamlessly forming a fabric having two opposing outer sides and a shared inner portion; the fabric has at least two peripheral edges defining where each row starts or ends, and the intertwining of the first and second knit filaments except for a first open length; and the first open length is defined by an absence of the twisting of the first and second knit filaments, providing a chamber within the shared inner portion.

In another aspect of the present invention, the knitting method for knitting a seamless fabric having an intrinsic pocket includes a first knit filament; a second knit filament; the first knit filament and the second knit filament are integrally knitted through a plurality of rows so as to be connected seamlessly forming a fabric having two opposing outer sides and a shared inner portion; the fabric has at least two peripheral edges defining where each row starts or ends, and the intertwining of the first and second knit filaments except for a first open length; the first open length is defined by an absence of the twisting of the first and second knit filaments, providing a pocket within the shared inner portion, wherein the first open length is approximately the size of the desired extrinsic object in length; slidably inserting at least one extrinsic object through the first open length so that each extrinsic object is sandwiched within the shared inner portion; and a plurality of barriers occurs by virtue of the first and second knit filaments crossing between the two outer sides, and wherein the chamber is defined in part by a subset of the plurality of barriers.

In yet another aspect of the present invention, the method provides a second opening length along an opposing peripheral edge of the two peripheral edges so that a passageway is defined between the first and second open lengths.

In another aspect of the present invention, the knitting method for knitting a seamless fabric having an intrinsic chamber includes a first knit filament; a second knit filament; the first knit filament and the second knit filament are integrally knitted through a plurality of rows so as to be connected seamlessly forming a fabric having two opposing outer sides and a shared inner portion; during the creation of the fabric, the first knit filament and second knit filament are passed from one side to the other, so that the facing filament is reversed. During creation, an extrinsic object is inserted, and again the first knit filament and the second knit filament are passed back, creating a closed off chamber with the extrinsic object permanently contained therein.

These and other features, aspects and advantages of the present invention will become better understood with reference to the following drawings, description and claims.

### BRIEF DESCRIPTION OF THE DRAWINGS

FIG. 1 is a side view of an exemplary embodiment of an opening in a selvage of the present invention;

FIG. 2 is a front view of an exemplary embodiment of a fabric of the present invention containing both passages and chambers;

FIG. 3 is a perspective view of an exemplary embodiment of the present invention, illustrating insertion of an extrinsic object into a closed chamber during creation of the fabric;

FIG. 4 is an elevational view of an exemplary embodiment of the present invention, illustrating extrinsic objects retained in a closed chamber of the fabric;

FIG. 5 is a perspective view of an exemplary embodiment of the present invention, illustrating extrinsic objects retained in the opening selvage chamber of the fabric;

FIG. 6 is a front view of an exemplary embodiment of the present invention, illustrating an intrinsic object inserted in the fabric; and

FIG. 7 is a top view of an exemplary embodiment of the present invention, illustrating an intrinsic object inserted in the fabric.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

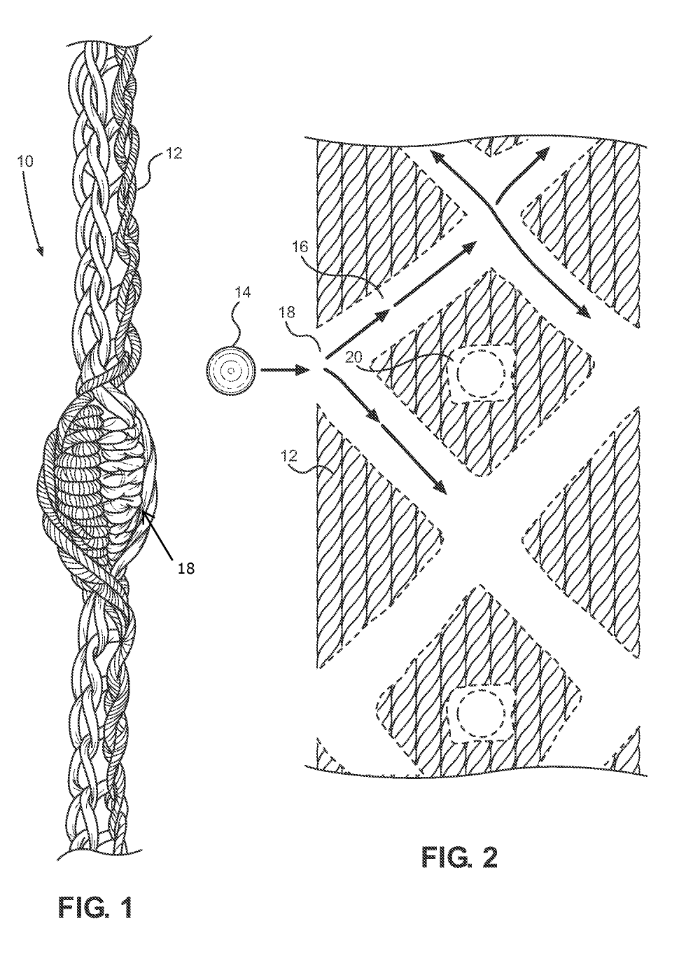

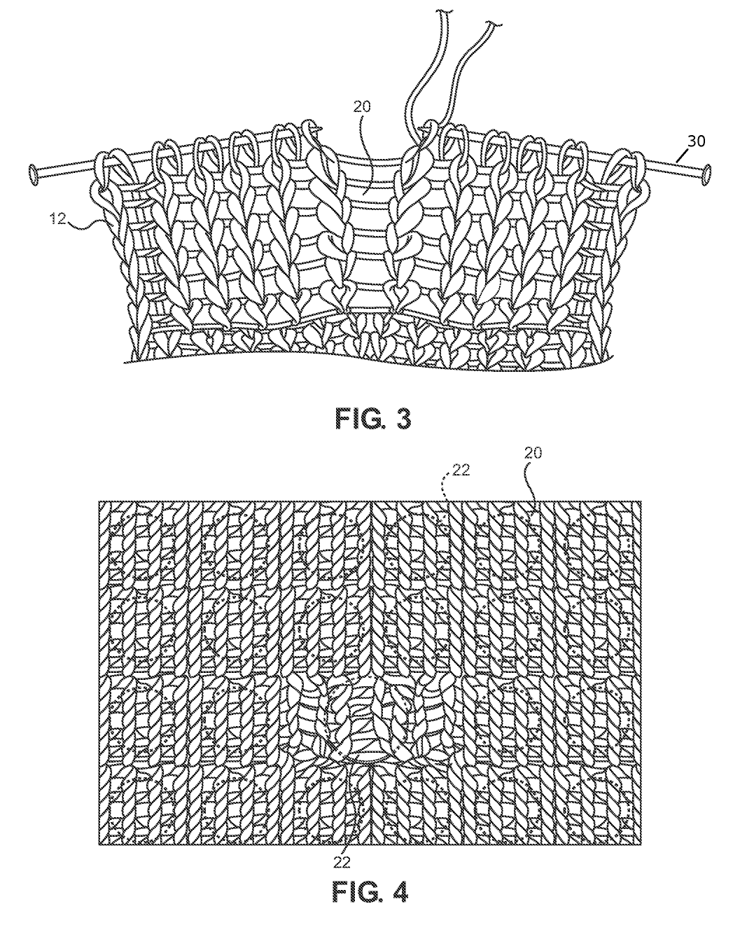

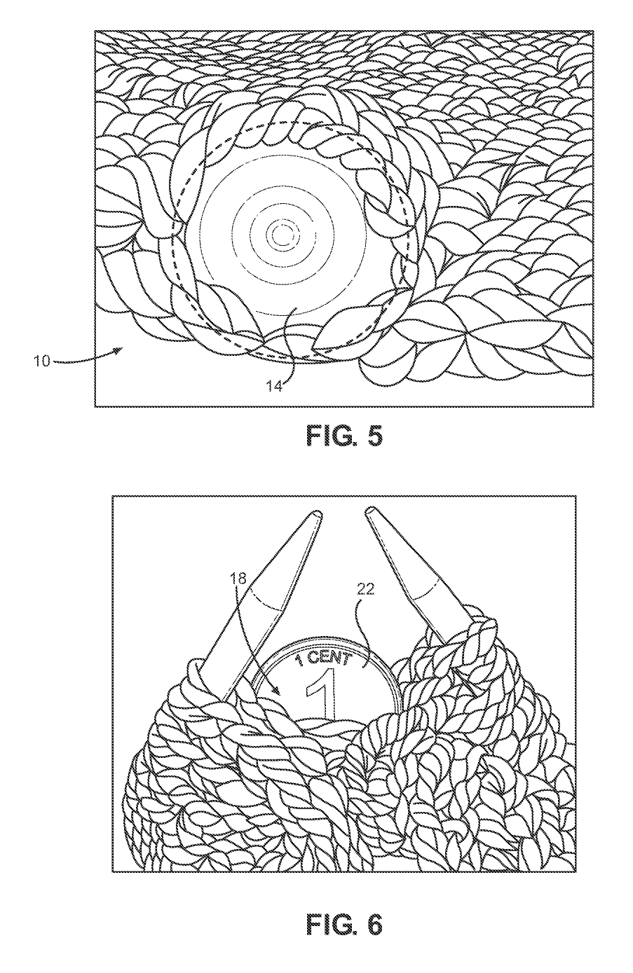

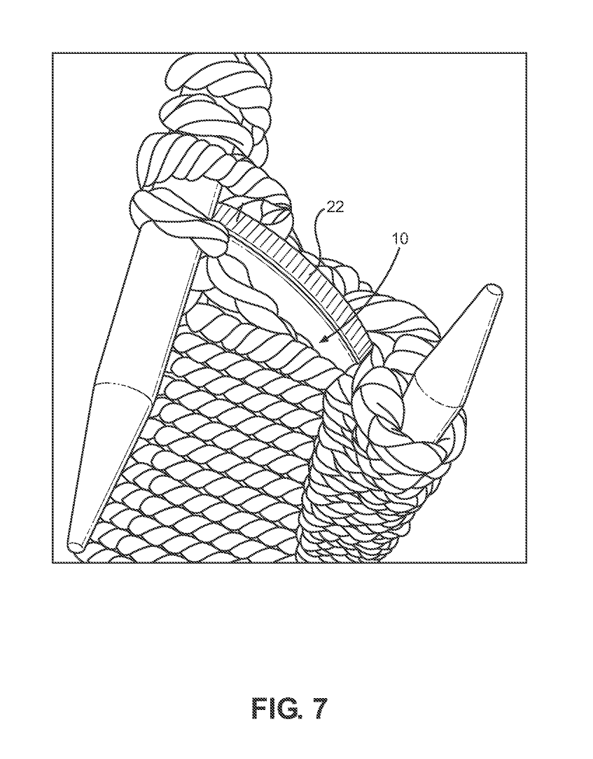

Referring now to FIGS. 1 through 7, the present invention may provide a unitary double-knit fabric adapted to provide intrinsic chambers 20 and passageways 16 for holding and passing, respectively, extrinsic objects 14, 22 therein and therethrough, and a method of making the same. The present invention may include: knitting needles 30, whose size may vary based on desired finished product; two or more lengths of filament 12, such as yarn, to be worked simultaneously with the knitting needles 30 (these filaments 12 can be the same or different colors depending on desired product, but typically are the same type and weight. Type and weight can vary based on the project, but typically match each other); a knitting pattern or schematic, not shown, that will guide creation of the final product (patterns will vary based on desired product); extrinsic object of choice 14, 22 (coin, marble, ball bearing, insulated material, etc.).

A method of making the present invention may include the following. A user may cast filament onto the knitting needles 30. The number of stitches cast on should be double the number of stitches facing one side of the finished product (Note: ‘facing’ refers to the side you are looking at a given time. A user would cast on double the number of stitches so that they have the same number on both sides of the fabric). The maker would proceed to turn work. Pass the first filament 12 over second filament 12 at start of each row to create a solid selvage 10 joining the two faces of the fabric. You can change which side a particular filament is facing during the creation of the fabric by passing the first knit filament and second knit filament from one outer side to the other, effectively switching the sides they are on so that the facing filament is reversed. In this context, facing filament refers to which of the two filaments you see on the side of the cloth facing you.

Knit as pattern dictates. Referring to FIG. 2, use steps (a) passage step and (b) chamber step below as needed throughout this process.
(a) To create the mouth of a passage: Refrain from passing one filament 12 over the other at the start of each row for appropriate number of rows. Do this until the mouth 18 in the selvage is the size needed to pass through desired intrinsic object 14, 22—facilitating a hole 18 in the selvage 10 that allows insertion and removal the intrinsic object 14, 22 from the fabric after the article is completed; and/or
(b) To create a pocket or chamber 20: When half way through the last row of a particular color block, slip the desired foreign object between the knitting needles 30, between the two halves of the fabric. Knit as directed by the pattern, closing off the mouth creating a closed pocket 20—enabling insertion of the extrinsic object 14, 22 during creation and permanently kept inside the two halves of the fabric.

The premise of a double-knit fabric is to have a cloth twice as thick as a regular fabric. This is achieved by knitting essentially two cloths at once, often times in two contrasting colors. As desired, the colors can cross back and forth from one side of the fabric to the other. This is done for an aesthetic effect, to have interesting patterns in the cloth, made up of different color blocks. The design on one side is the inverse of the design on the opposite side.

At the change of one color block to another, a natural barrier occurs by virtue of the strands of filament 12 crossing from one side to the other. Thus, a pocket or chamber 20 is formed on the inside of the fabric, closed in by the barriers of filament 12 and the two sides of the fabric.

The present invention utilizes those barriers. A knitter working a double-knit project may twist the filaments 12 (or, pass one filament 12 over the other) at the start of each row so as to create a smooth, continuous selvage 10. By not twisting the filaments 12 for a number of rows, a hole or mouth is created in the selvage 10 that could allow an extrinsic object 14, 22 into the cloth. An example of this would be to leave one inch of the edge of a scarf open. From there a user may knit a pattern that looks like a maze, and then introduce a marble as the extrinsic object 14. Then the user or wearer may push the marble 14 through the maze by manually working the marble 14 through the passages 16 afforded by the fabric.

In addition, one can add in an extrinsic object 14, 22 while knitting the cloth. Then, once the colors are switched again, the extrinsic object 14, 22 will remain in place until the cloth is destroyed. An example of this would be to knit a vest with a checkerboard pattern. As the user knits the pattern, when they come to a row where they want to switch colors to create a new row of squares, the user may slip some insulating material as the extrinsic object 14, 22 in-between the needles 30.

One could apply this process to any double-knit pattern in the knitting lexicon. However, the inventor has authored patterns that specifically use this pattern. When double knitting, refrain from twisting the filament 12 at the start of a row for approximately and (¾ to 1 ¼) inch's worth of cloth, facilitating a hole 18 that can be used to pass an extrinsic object 14, 22 through the fabric. If one does the same on the far end of the cloth, one can pass the extrinsic object 14, 22 all the way through from one end to the other—via a passage way 16—as long as the design permits it. In addition, when halfway through the last row of a particular color block, slip the desired extrinsic object 14, 22 between the knitting needles 30, between the two halves of the fabric. Knit as directed by the pattern, closing off the mouth 18 creating a closed pocket 20.

Knitting needles 30, filament 12, and an idea of the pattern are necessary. The nature of the foreign object to use depends on the knitter's desired outcome for the cloth. You may make chambers, passages, or both, depending on your needs.

Chambers and passages can be applied wherever you like in the pattern, and in any order, depending on color placement (i.e., you cannot have a passage if the pattern is checkerboard, as each change in color creates a barrier. You would need to leave a path for the foreign object to pass through). By using this process described herein, passages 16, and pockets/chambers 20 can be knit into a double-knit cloth without unsightly seams or extra fabric.

Additionally, the present invention is generally applicable to making cloth and clothes, but it could also be used to make tools, toys, perhaps even used in the making of fences, electrical wiring, etc., so long as a double knitted technology applies. This process can allow for these and many more applications, some of which have yet to be imagined.

It should be understood, of course, that the foregoing relates to exemplary embodiments of the invention and that modifications may be made without departing from the spirit and scope of the invention as set forth in the following claims.

What is claimed is:

1. A knitting method for knitting a seamless fabric having an intrinsic pocket for receiving at least one extrinsic object: wherein
a first knit filament;
a second knit filament;
the first knit filament and the second knit filament are integrally knitted through a plurality of rows so as to be connected seamlessly forming a fabric having two opposing outer sides and a shared inner portion;
the fabric has at least two selvages defining where each row starts or ends, and the intertwining of the first and second knit filaments except for a first open length;
the first open length is defined by an absence of the twisting of the first and second knit filaments at the start of a number of rows, providing an opening in the selvage to an intrinsic pocket within the shared inner portion, wherein the first open length is dimensioned to receive the at least one extrinsic object.

2. The method of claim 1, wherein the first open length is approximately one inch.

3. The method of claim 1, slidably inserting the at least one extrinsic object through the first open length so that each extrinsic object is sandwiched within the shared inner portion, and can be passed in and out, back and forth through the shared inner portion.

4. A knitting method for knitting a seamless fabric having an intrinsic chamber: wherein
a first knit filament;
a second knit filament;
the first knit filament and the second knit filament are integrally knitted through a plurality of rows so as to be connected seamlessly forming a fabric having two opposing outer sides and a shared inner portion;
during the creation of the fabric, the first knit filament and second knit filament are passed from one outer side to the other, so that the either first knit filament or the second knit filament facing filament is reversed;
succeeding rows are knit without passing the first and second filaments between a portion of the outer sides defining a chamber; and
following creation of the portion of outer sides containing the chamber, an extrinsic object is inserted, and again the first knit filament and the second knit filament are passed back, creating a closed off chamber with the extrinsic object retained therein.

5. The method of claim 4, wherein a plurality of barriers occurs by virtue of the first and second knit filaments passing between the two outer sides, and wherein the chamber is defined in part by a subset of the plurality of barriers.

6. A knitting method for knitting a seamless fabric having an intrinsic passageway to accommodate at least one extrinsic object: wherein
a first knit filament;
a second knit filament;
the first knit filament and the second knit filament are integrally knitted through a plurality of rows so as to be connected seamlessly forming a fabric having two opposing outer sides and a shared inner portion;
the fabric has at least one selvage defining where each row starts or ends, and the intertwining of the first and second knit filaments except for a first open length;
the first open length is defined by an absence of the twisting of the first and second knit filaments at the start of a number of rows, providing an opening in the at least one selvage communicating to the shared inner portion, wherein the first open length is approximately a circumference of one of the at least one extrinsic object;
inserting at least one extrinsic object through the first open length so that each extrinsic object is sandwiched within the shared inner portion; and
a plurality of barriers occurs by virtue of the first and second knit filaments crossing between the two outer sides, and wherein the passageway is defined in part by a subset of the plurality of barriers.

7. The method of claim 6, providing a second open length along one of the at least one selvage, so that a passageway is defined between the first and second open lengths for sliding the at least one extrinsic objects therethrough.
